(19) United States
(12) Patent Application Publication
(10) Pub. No.: US 2018/0067971 A1
(43) Pub. Date: Mar. 8, 2018

(54) Image Search Method, Apparatus and Storage Medium

(71) Applicant: Baidu Online Network Technology (Beijing) Co., Ltd., Beijing (CN)

(72) Inventor: Tong Yan, Beijing (CN)

(73) Assignee: Baidu Online Network Technology (Beijing) Co., Ltd., Beijing (CN)

(21) Appl. No.: 15/504,189

(22) PCT Filed: Oct. 21, 2015
(86) PCT No.: PCT/CN2015/092415

§ 371 Date: Feb. 15, 2017

(30) Foreign Application Priority Data
May 21, 2015 (CN) 201510262791.X

(51) Int. Cl. G06F 17/30; G06K 9/00

(52) U.S. Cl. CPC G06F 17/30277; G06K 9/00402; G06F 17/30247

(57) ABSTRACT

The embodiments of the present disclosure disclose an image search method, apparatus and storage medium. The image search method comprises: displaying an image; recognizing, based on a curve drawn by a user on the image, an enclosed region; determining, based on the enclosed region, a search target in the image; initiating, based on a search instruction entered by the user, a search request based on the search target. The image search method and apparatus according to the embodiments of the present disclosure may easily identify a pictorial image corresponding to a to-be searched object from the search image.

### CROSS REFERENCE TO RELATED APPLICATION

This application claims the priority of Chinese Patent Application No. 201510262791.X, entitled “Image Search Method, Apparatus and Storage Medium,” filed by Baidu Online Network Technology (Beijing) Co., Ltd., on May 21, 2015, the content of which is incorporated herein by reference in its entirety.

### TECHNICAL FIELD

The embodiments of the present disclosure relate to the field of search engine technology, specifically to an image search method, apparatus and storage medium.

### BACKGROUND

With the prevailing of Internet technology today, search engines have become an indispensable tool in our ordinary life. Image search technology begins to appear as the search engine technology matures by the day. As compared with the relatively mature text search that has been researched and practiced for years, image search lags behind in both theoretical research and engineering implementation. On the basis of the existing technologies for implementing an image search engine, image search engines may be divided into text-based image search engines, content-based image search engines and semantics-based image search engines.

The content-based image search technology uses the visual characteristics of the image, e.g., color, texture, shape, as the representative characteristics of the image to seek and match, and to obtain subsequently search results the user may need. The existing content-based image search engine generally requires the background of the to-be-searched image provided by the user to be as simple as possible, to facilitate the identification of the object the user desires to search in the image. However, in practice, the search image provided by the user does not always comply with such a requirement. For instance, a user needs to search a building he/she passes by, and the building is located between many buildings. It would be difficult to find a desirable shooting angle to only photograph the building to be searched. Therefore, it results in the difficulty of obtaining an image of the building with a simple background. Because of the above reason, the image search is neither widely applicable nor very popular.

### SUMMARY

The embodiments of the present disclosure provide an image search method, apparatus and storage medium, for easily identifying a pictorial image corresponding to a to-be-searched object from the search image.

In a first aspect, the embodiments of the present disclosure provide an image search method, comprising:

displaying an image;

recognizing, based on a curve drawn by a user on the image, an enclosed region;

determining, based on the enclosed region, a search target in the image; and

initiating, based on a search instruction entered by the user, a search request based on the search target.

In a second aspect, the embodiments of the present disclosure further provide an image search apparatus, comprising:

a display module configured to display an image;

a recognition module configured to recognize an enclosed region based on a curve drawn by a user on the image;

a target determination module configured to determine a search target in the image based on the enclosed region; and

a request module configured to initiate, based on a search instruction entered by the user, a search request based on the search target.

In a third aspect, the embodiments of the present disclosure provide a storage medium containing computer executable instruction, the computer executable instruction being configured to execute an image search method when executed by a computer processor, the method comprising:

displaying an image;

recognizing, based on a curve drawn by a user on the image, an enclosed region;

determining, based on the enclosed region, a search target in the image; and

initiating, based on a search instruction entered by the user, a search request based on the search target.

In accordance with the image search method, apparatus and storage medium provided by the embodiments of the present disclosure, a pictorial image corresponding to a to-be-searched object can be easily identified from the search image by: displaying an image, recognizing, based on a curve drawn by a user on the image, an enclosed region, determining, based on the enclosed region, a search target in the image, and initiating, based on a search instruction entered by the user, a search request based on the search target.

### BRIEF DESCRIPTION OF THE DRAWINGS

To describe the technical solutions in the embodiments of the present disclosure more clearly, the accompanying drawings required for describing the embodiments will be briefly described as follows. Naturally, the accompanying drawings in the following description show merely some embodiments of the present disclosure, and those skilled in the art may make modifications and substitutions to these drawings without inventive efforts.

FIG. 1 is a flowchart of the image search method according to a first embodiment of the present disclosure;

FIG. 2 is a flowchart showing identification in the image search method according to a second embodiment of the present disclosure;

FIG. 3 is a flowchart of the image search method according to a third embodiment of the present disclosure;

FIG. 4 is a flowchart of the image search method according to a fourth embodiment of the present disclosure;

FIG. 5 is a flowchart of the image search method according to a fifth embodiment of the present disclosure;

FIG. 6A is a diagram of an image display interface before the image is distinctively-displayed and label-displayed according to the fifth embodiment of the present disclosure;

FIG. 6B is a diagram of an image display interface after the image is distinctively-displayed and label-displayed according to the fifth embodiment of the present disclosure;

FIG. 7 is a flowchart showing target determination in the image search method according to a sixth embodiment of the present disclosure; and

FIG. 8 is a structural diagram of an image search apparatus according to a seventh embodiment of the present disclosure.

### DETAILED DESCRIPTION OF THE EMBODIMENTS

The technical solutions in the embodiments of the present disclosure will be clearly and completely described below in combination with the accompanying drawings. Evidently, the described embodiments are part of the embodiments of the present disclosure rather than all of the embodiments. The described embodiments are used to explain the principals of the present disclosure, rather than limit the present disclosure to these specific embodiments. All other embodiments obtained by those skilled in the art, based on the embodiments of the present disclosure and without inventive efforts, fall into the protection scope of the present disclosure.

### First Embodiment

The present embodiment provides a technical solution to an image search method. The technical solution may be executed by an image search apparatus, which may be integrated into a computing device on the user's side, such as smart mobile terminals or PCs.

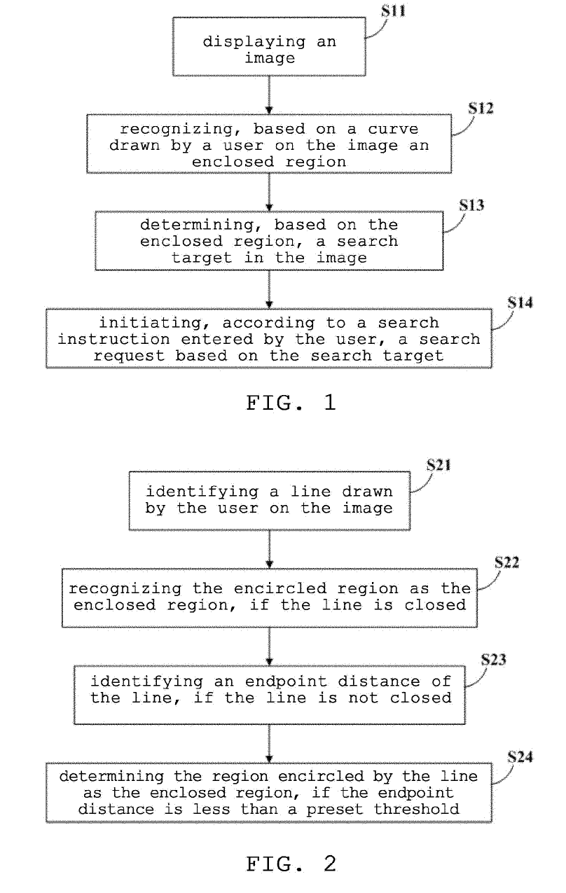

Specifically, referring to FIG. 1, the image search method comprises:

S11, displaying an image.

Before initiating an image search by utilising a search target in the image, an image for obtaining the search target needs to be acquired and displayed. The image may be taken by a user with a camera or downloaded from the internet.

S12, recognizing, based on a curve drawn by a user on the image an enclosed region.

After the image is displayed on the screen, the curve drawn by the user on the screen is acquired and an enclosed region is recognized on the image based on the curve. The enclosed region is an area encircled by the curve.

It is understandable that sometimes the curve drawn by the user on the screen does not meet the requirements. Particularly, the curve drawn by the user on the screen may not be entirely enclosed. In this situation, an enclosed region corresponding to the curve can be recognized based on the starting point and end point of the curve. Specifically, by connecting the starting point and the endpoint with a straight line to mend the not entirely enclosed curve and making it a closed curve, the area covered by the closed curve after the mending is recognized as the enclosed region.

S13, determining, based on the enclosed region, a search target in the image.

After the enclosed region corresponding to the curve is determined, a search target is to be further determined based on the enclosed region. The search target is the target of the search request that will be initiated by the user. The target object may be an object or a person. In addition, the search target should be corresponding to a specific pictorial image area in the image.

It should be appreciated that the pictorial image area corresponding to the search target may be different than the extent of the enclosed region. For example, in some part of the image, the extent of the pictorial image area corresponding to the search target is greater than the extent of the enclosed region, while in other parts of the image, the extent of the pictorial image area corresponding to the search target is smaller than the extent of the enclosed region. The actual extent of the pictorial image area corresponding to the search target should depend on the determination result after determining the search target.

S14, initiating, according to a search instruction entered by the user, a search request based on the search target.

After the search target is determined in the image, a search instruction may be received from the user. Preferably, a display module used for enter a search instruction is displayed to the user after the search target is determined, and the search instruction entered by the user is acquired based on the user's operation on the display module.

After the search request entered by the user is acquired, according to the search instruction, an Internet search request is initiated for the search target.

By displaying an image, recognizing an enclosed region based on a curve drawn by the user on the image, determining a search target based on the enclosed region in the image, initiating a search request based on the search target according to a search instruction entered by the user, the present embodiment can easily identify a pictorial image corresponding to the to-be-searched object from the search image.

### Second Embodiment

This embodiment is based on the above embodiment of the present disclosure, and further provides a technical solution to the identification operation of the image search method. In the technical solution, the recognizing, based on a curve drawn by a user on the image, an enclosed region, comprises: identifying a line drawn by the user on the image; recognizing the encircled region as the enclosed region, if the line is closed; identifying an endpoint distance of the line, if the line is not closed; determining the region encircled by the line as the enclosed region, if the endpoint distance is less than a preset threshold.

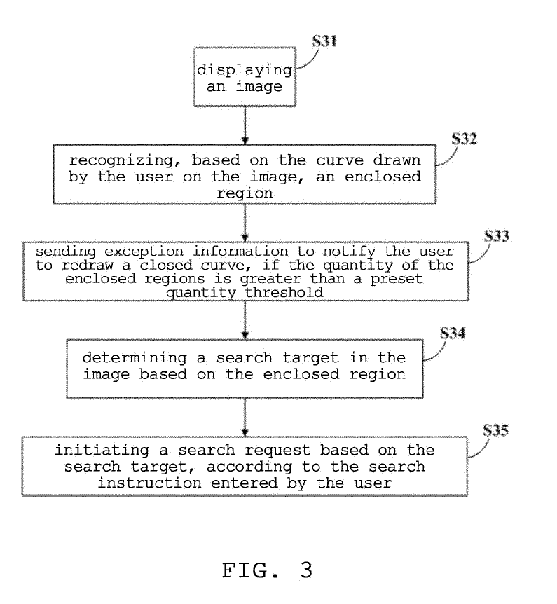

Referring to FIG. 2, recognizing, based on a curve drawn by a user on the image, an enclosed region comprises:

S21, identifying a line drawn by the user on the image.

It should be appreciated that the sliding trace on the screen entered by the user constitutes the line drawn on the image. The line in itself should be closed or nearly closed.

S22, recognizing the encircled region as the enclosed region, if the line is closed.

When the line drawn by the user on the image constitutes a closed line, recognize the region encircled by the line on the image, i.e. the encircled region, as the enclosed region. The spatial scale of the enclosed region should be less than the display extent of the image.

S23, identifying an endpoint distance of the line, if the line is not closed.

In relation to a line that is not closed, if the distance between the two endpoints, i.e. the starting point and the end point, of the line is not large, the enclosed region can still be determined based on the line. The particular operation is to first identify the distance between the two endpoints of the line.

S24, determining the region encircled by the line as the enclosed region, if the endpoint distance is less than a preset threshold.

A preset threshold is pre-set for the endpoint distance which enables the identification of the enclosed region. If the endpoint distance is less than the preset threshold, the region encircled by the line can still be determined as the enclosed region.

The present embodiment defines the region encircled by the line as the enclosed region through the recognization of the enclosed region by the line drawn by the user on the image. When the line is closed, the encircled region is determined as the enclosed region. When the line is not closed, the endpoint distance of the line is identified to ensure the endpoint distance is less than a preset threshold. Accordingly, not only can the enclosed region be recognized by the closed line, but also by the non-closed line inputted by the user. The fault tolerance of the image search method is improved.

### Third Embodiment

Based on the above embodiments of the present disclosure, the present embodiment further provides a technical solution to the image search method. The technical solution, after the recognizing, based on a curve drawn by a user on the image, an enclosed region, further comprises: sending exception information to the user, to notify the user to redraw a closed curve, if the quantity of the enclosed regions is greater than a preset threshold.

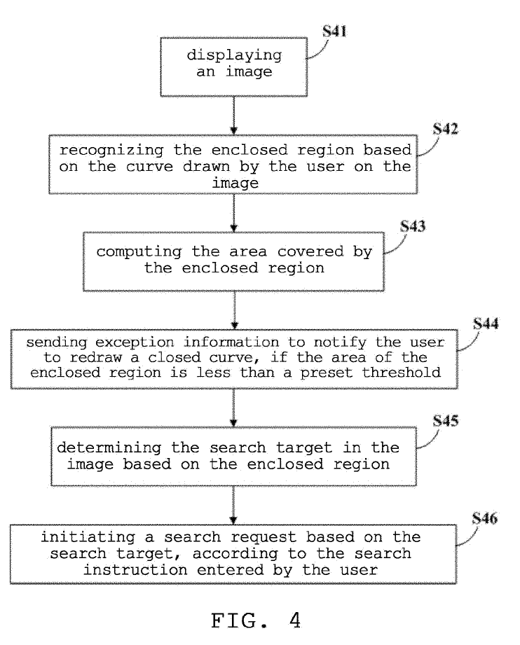

Referring to FIG. 3, the image search method comprises:

S31, displaying an image.

S32, recognizing, based on the curve drawn by the user on the image, an enclosed region.

S33, sending exception information to notify the user to redraw a closed curve, if the quantity of the enclosed regions is greater than a preset quantity threshold.

If multiple enclosed regions are identified based on the curves drawn by the user, it becomes difficult to determine a single search target based on the enclosed regions. Therefore, if the quantity of the enclosed regions is greater than a preset quantity threshold, send exception information to notify the user and cease executing the act of locating a search target.

S34, determining a search target in the image based on the enclosed region.

S35, initiating a search request based on the search target, according to the search instruction entered by the user.

The present embodiment sends exception information to the user, after the recognition of the enclosed region based on the curve drawn by the user on the image, to notify the user to redraw a closed curve, if the quantity of the enclosed regions is greater than a preset quantity threshold. Accordingly, the situation of multiple co-existing enclosed regions leading to difficulty in locking the search target is avoided, and the reliability of the image search method is improved.

### Fourth Embodiment

Based on the above embodiments of the present disclosure, the present embodiment further provides a technical solution to the image search method. The technical solution, after the recognizing, based on a curve drawn by a user on the image, an enclosed region, further comprises: computing the area covered by the enclosed region; sending exception information to the user to notify the user to redraw a closed curve, if the area is less than a preset area threshold.

Referring to FIG. 4, the image search method comprising:

S41, displaying an image.

S42, recognizing the enclosed region based on the curve drawn by the user on the image.

S43, computing the area covered by the enclosed region.

Under certain circumstances, the area of the enclosed region recognized based on the curve drawn by the user is undersized. To further determine a search target based on such enclosed region will add difficulty to the identification of the search target. Therefore, before determining the search target, it is necessary to compute and differentiate the area of the enclosed region.

Specifically, when performing the computation and differentiation on the area of the enclosed region, the area of the enclosed region needs to be calculated first.

S44, sending exception information to notify the user to redraw a closed curve, if the area of the enclosed region is less than a preset threshold.

There is a preset area threshold for the area enclosed by the enclosed region. The area threshold is a lower threshold. In other words, if the area is less than the area threshold, the enclosed region is an exception. An exception information is sent to notify the user and further determination operation for the search target is ceased.

S45, determining the search target in the image based on the enclosed region.

S46, initiating a search request based on the search target, according to the search instruction entered by the user.

The present embodiment computes the area of the enclosed region and sends exception information to the user, after the recognition of the enclosed region based on the curve drawn by the user on the image, to notify the user to redraw a closed curve, if the area of the enclosed region is less than a preset area threshold. Accordingly, the situation of determination of the search target in an undersized enclosed region is avoided, and the reliability of the image search method is improved.

### Fifth Embodiment

Based on the above embodiments of the present disclosure, the present embodiment further provides a technical solution to the image search method. The technical solution, after the determining, based on the enclosed region, a search target in the image, further comprises: displaying distinctively the search target in the image; creating and displaying a search label for the search target, the search label being provided for the user to enter the search instruction.

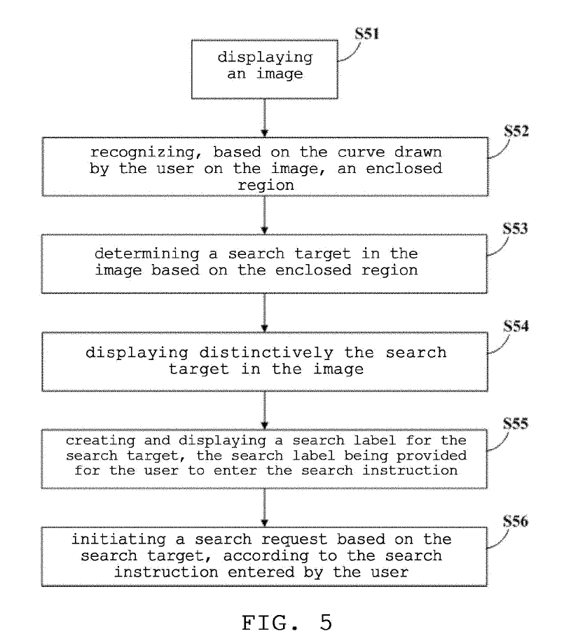

Referring to FIG. 5, the method for searching an image comprising:

S51, displaying an image.

S52, recognizing, based on the curve drawn by the user on the image, an enclosed region.

S53, determining a search target in the image based on the enclosed region.

S54, displaying distinctively the search target in the image.

In the present embodiment, after determining the search target in the enclosed region, display distinctively the determined search target. In particular, the distinctive displaying may be a highlighted display of the search target.

S55, creating and displaying a search label for the search target, the search label being provided for the user to enter the search instruction.

After distinctive displaying of the search target, display the search label 62 on the display interface. The search label 62 can be a button or other display controls.

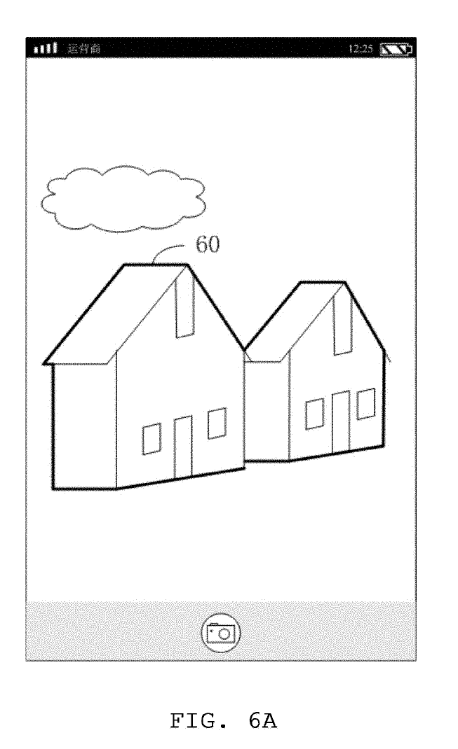

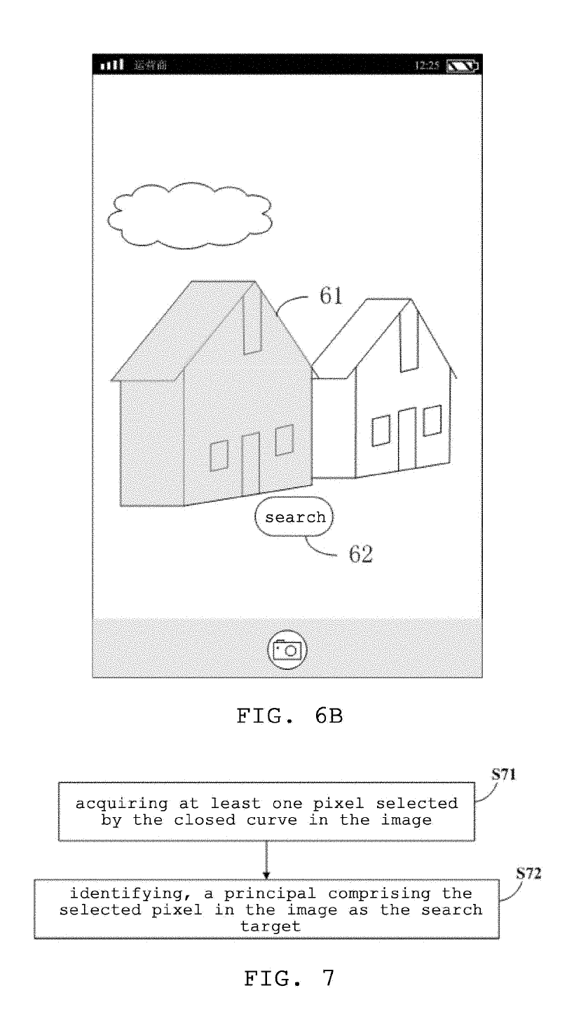

FIGS. 6A and 6B are respectively diagrams of the display interfaces before and after the image is distinctively displayed and label-displayed. Referring to FIGS. 6A and 6B, after determining the search target 61 based on the curve 60 drawn by the user, display distinctively the search target 61 and label-display the search label 62 for the user to enter the search instruction around the search target.

S.56, initiating a search request based on the search target, according to the search instruction entered by the user.

The present embodiment displays distinctively the search target in the image, creates and displays a search label for the search target, after the determination of the search target in the image based on the enclosed region. Accordingly, the present embodiment facilitates the initiation of the search request according to the instruction entered by the user based on the search target.

### Sixth Embodiment

Based on the above embodiments of the present disclosure, the present embodiment further provides a technical solution to the image search method on target determination. In the technical solution, the determining, based on the enclosed region, a search target in the image comprises: acquiring at least one pixel selected by the closed curve in the image; identifying the principal comprising the selected pixel in the image as the search target.

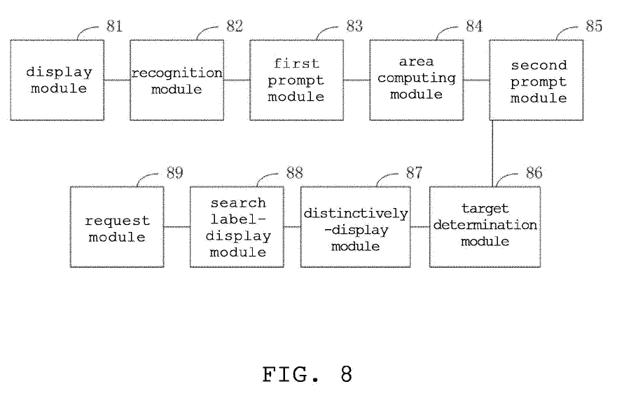

Referring to FIG. 7, determining the search target in the image based on the enclosed region, includes:

S71, acquiring at least one pixel selected by the closed curve in the image.

It should be appreciated that although the closed curve in the image is designated to identify the search target, the enclosed region may still include image irrelevant to the search target. To further identify the search target easily from the enclosed region, the user can select at least one pixel of the search target in the enclosed region, after encircling the enclosed region in the image. Accordingly, the operation of determining the search target includes acquiring at least one pixel of the search target.

S72, identifying, a principal comprising the selected pixel in the image as the search target.

After acquiring the at least one pixel, the principal comprising the pixel in the image is identified as the search target.

The present embodiment acquires at least one pixel selected by the closed curve in the image and identifies the principal comprising the pixel in the image as the search target. Accordingly, the present embodiment facilitates the identification of the search target.

### Seventh Embodiment

The present embodiment provides a technical solution to the image search apparatus. Referring to FIG. 8, in the technical solution, the image search apparatus comprises: a display module 81, a recognition module 82, a target determination module 86 and a request module 89.

The display module 81 is configured to display an image.

The recognition module 82 is configured to recognize an enclosed region based on a curve drawn by a user on the image.

The target determination module 86 is configured to determine a search target in the image based on the enclosed region.

The request module 89 is configured to initiate, according to a search instruction entered by the user, a search request based on the search target.

The identification module 82 may further include: a line identification submodule, a first region recognition submodule, a distance identification submodule and a second region recognition submodule.

The line identification submodule is configured to identify a line drawn by the user on the image.

The first region recognition submodule is configured to recognize the encircled region as the enclosed region, if the line is closed.

The distance identification submodule is configured to identify an endpoint distance of the line, if the line is not closed.

The second region recognition submodule is configured to recognize the region encircled by the line as the enclosed region, if the endpoint distance of the line is less than a preset threshold.

The image search apparatus may further comprises: a first prompt module 83.

The first prompt module 83 is configured to send exception information to notify the user to redraw a closed curve, if the quantity of the enclosed region is greater than a preset quantity threshold, after the enclosed region is recognized based on the curve drawn by the user on the image.

The image search apparatus may further comprises: an area computing module 84 and a second prompt module 85.

The area computing module 84 is configured to compute the area covered by the enclosed region after the enclosed region is recognized based on the curve drawn by the user on the image.

The second hint module 85 is configured to send exception information to notify the user to redraw a closed curve, if the area of the enclosed region is less than a preset threshold.

The image search apparatus may further comprises: a distinctively-display module 87 and a search label-display module 88.

The distinctively-display module 87 is configured to display distinctively the search target in the image after the search target is determined based on the enclosed region in the image.

The search label-display module 88 is configured to create and display a search label for the search target, the search label being provided for the user to enter the search instruction.

The target determination module may further comprises: a pixel acquisition submodule and a principal identification submodule.

The pixel acquisition submodule is configured to acquire at least one pixel selected by the closed curve in the image.

The principal identification submodule is configured to identify a principal comprising the pixel in the image as the search target.

The above-mentioned image search apparatus may implement the image search methods according to any of the embodiments of the present disclosure, and have the functional modules and advantageous effect corresponding to the implementations of the method.

Those skilled in the art should understand that each of the above-mentioned modules or steps of the present disclosure may be implemented by a general computing device and may be collectively implemented on a single computing device or distributed on a network formed by several computing devices. Alternatively, they may be implemented by program codes executable by a computer device so that they may be stored in a storage device to be executed by a computing device, or they may be separately implemented into individual integrated circuit modules, or many modules or steps thereof may be implemented into a single integrated circuit module to be implemented. Accordingly, the present disclosure is not limited to any particular combination of hardware and software.

### Eighth Embodiment

A storage medium containing computer executable instructions, the computer executable instructions being configured to execute an image search method when executed by a computer processor, the method comprising:

displaying an image;

recognizing, based on a curve drawn by a user on the image, an enclosed region;

determining, based on the enclosed region, a search target in the image; and

initiating, based on a search instruction entered by the user, a search request based on the search target.

When executing the method stored as computer executable instructions in the storage medium, the recognizing the enclosed region based on curve drawn by the user on the image, may further comprise:

identifying a line drawn by the user on the image;

recognizing the encircled region as the enclosed region, if the line is enclosed;

identifying an endpoint distance of the line, if the line is not closed; and

determining the region encircled by the line as the enclosed region, if the endpoint distance is less than a preset threshold.

When executing the method, after recognizing the enclosed region based on the curve drawn by the user on the image, the storage medium may further comprise:

sending exception information to the user to notify the user to redraw a closed curve, if the quantity of the enclosed regions is greater than a preset quantity threshold.

When executing the method, after recognizing the enclosed region based on the curve drawn by the user on the image, the storage medium may further comprise:

computing the area covered by the enclosed region; and

sending exception information to the user to notify the user to redraw a closed curve, if the area is less than a preset area threshold.

When executing the method, after determining a search target based on the enclosed region in the image, the storage medium may further comprise:

displaying distinctively the search target in the image; and

creating and displaying a search label for the search target, the search label being provided for the user to enter the search instruction.

When executing the method, the determining the search target based on the enclosed region in the image, may further comprise:

acquiring at least one pixel selected by the closed curve in the image; and

identifying, a principal comprising the selected pixel in the image as the search target.

Those skilled in art may readily appreciate, through the foregoing description of the implementations, that the present disclosure may be implemented by software and necessary hardware. Naturally, the present disclosure may be implemented by hardware. However, the former is a better implementation in many cases. Based on such understanding, the technical solution of the present disclosure, or the portion that contributes over the prior art may be substantively represented in the form of software products. The computer software products may be stored in computer readable storage media, for example, a disk, an optical disk, a read-only memory (ROM) or a random access memory (RAM), and include instructions for causing a computer device (which may be a personal computer, a server, or a network device, etc.) to execute the methods described in each embodiment of the present disclosure.

It should be noted that in the embodiments of the above-mentioned image search apparatus, the included modules and sub-modules are delineated based on the functional logic, but not limited to the above-mentioned delineation as long as the corresponding functions can be achieved. Furthermore, the specific name of each functional unit is merely for facilitating distinguishing the functional units from one another, and does not intend to limit the protection scope of the present disclosure.

Each of the implementations in the description is described progressively, each of the implementations is focused on its differences from other implementations. The identical or similar portions in each of the implementations can refer to one another.

The foregoing is merely specific implementations of the present disclosure, the protection scope of the present disclosure is not limited thereto. Any variations or substitutions readily conceivable to those skilled in the art within the disclosed technical scope of the present disclosure shall fall into the protection scope of the present disclosure. Accordingly, the protection scope of the present disclosure is determined by the protection scope of the claims.

1. An image search method, comprising:
displaying an image;
recognizing, based on a curve drawn by a user on the image, an enclosed region;
determining, based on the enclosed region, a search target in the image; and
initiating, based on a search instruction entered by the user, a search request based on the search target.

2. The method according to claim 1, wherein the recognizing, based on a curve drawn by a user on the image, an enclosed region, comprises:
identifying a line drawn by the user on the image;
recognizing the encircled region as the enclosed region, if the line is closed;
identifying an endpoint distance of the line, if the line is not closed; and
determining the region encircled by the line as the enclosed region, if the endpoint distance is less than a preset threshold.

3. The method according to claim 1, wherein after the recognizing, based on a curve drawn by a user on the image, an enclosed region, the method further comprises:
sending exception information to the user to notify the user to redraw a closed curve, if the quantity of the enclosed regions is greater than a preset quantity threshold.

4. The method according to claim 1, after the recognizing, based on a curve drawn by a user on the image, an enclosed region, the method further comprises:
computing the area covered by the enclosed region; and
sending exception information to the user to notify the user to redraw a closed curve, if the area is less than a preset area threshold.

5. The method according to claim 1, after the determining, based on the enclosed region, a search target in the image, the method further comprises:
displaying distinctively the search target in the image; and
creating and displaying a search label for the search target, the search label being provided for the user to enter the search instruction.

6. The method according to claim 1, the determining, based on the enclosed region, a search target in the image, comprises:
acquiring at least one pixel selected by the closed curve in the image; and
identifying, a principal comprising the selected pixel in the image as the search target.

7. An image search apparatus, comprising:
at least one processor; and
a memory storing instructions, which when executed by the at least one processor, cause the at least one processor to perform operations, the operations comprising:
displaying an image;
recognizing an enclosed region based on a curve drawn by a user on the image;
determining a search target in the image based on the enclosed region; and
initiating, according to a search instruction entered by the user, a search request based on the search target.

8. The apparatus according to claim 7, wherein the recognizing, based on a curve drawn by a user on the image, an enclosed region, comprises:
identifying a line drawn by the user on the image;
recognizing the encircled region as the enclosed region, if the line is closed;
identifying an endpoint distance of the line, if the line is not closed; and
recognizing the region encircled by the line as the enclosed region, if the endpoint distance of the line is less than a preset threshold.

9. The apparatus according to claim 7, the operations further comprising:
sending exception information to notify the user to redraw a closed curve, if the quantity of the enclosed region is greater than a preset quantity threshold, after the enclosed region is recognized based on the curve drawn by the user on the image.

10. The apparatus according to claim 7, the operations further comprising:
computing the area covered by the enclosed region after the enclosed region is recognized based on the curve drawn by the user on the image; and
sending exception information to notify the user to redraw a closed curve, if the area of the enclosed region is less than a preset threshold.

11. The apparatus according to claim 7, the operations further comprising:
displaying distinctively the search target in the image after the search target is determined based on the enclosed region in the image; and
creating and display a search label for the search target, the search label being provided for the user to enter the search instruction.

12. The apparatus according to claim 7, wherein the determining, based on the enclosed region, a search target in the image comprises:
acquiring at least one pixel selected by the closed curve in the image; and
identifying a principal comprising the pixel in the image as the search target.

13. A storage medium containing computer executable instruction, the computer executable instruction being configured to execute an image search method when executed by a computer processor, the method comprising:
displaying an image;
recognizing, based on a curve drawn by a user on the image, an enclosed region;
determining, based on the enclosed region, a search target in the image; and
initiating, based on a search instruction entered by the user, a search request based on the search target.
